(19) United States
(12) Patent Application Publication
(10) Pub. No.: US 2004/0218001 A1
(43) Pub. Date: Nov. 4, 2004

(54) Liquid ejecting apparatus and method for controlling the liquid ejecting apparatus

(75) Inventors: Masaru Takahashi, Nagano (JP); Hiroyuki Ito, Nagano (JP); Seiji Tojo, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/758,276

(22) Filed: Jan. 16, 2004

(30) Foreign Application Priority Data
Jan. 17, 2003 (JP) P.2003-009598

(51) Int. Cl. B41J 2/165

(52) U.S. Cl. 347/30

(57) ABSTRACT

A liquid ejecting apparatus includes a liquid ejecting head having a nozzle from which a liquid is ejected, a capping unit sealing the liquid ejecting head, a tube pump applying a negative pressure to the capping unit by rotating operation to suck a fluid, and a controller varying a rotation speed of the tube pump. The controller rotates the tube pump at a first rotation speed for a first predetermined time. The controller rotates the tube pump at a second rotation speed lower than the first rotation speed for a second predetermined time after rotating the tube pump at the first rotation speed for the first predetermined time.

### BACKGROUND OF THE INVENTION

The present invention relates to a liquid ejecting apparatus for varying the rotation speed of a tube pump during cleaning and a method for controlling the liquid ejecting apparatus.

Recently, one of liquid ejecting apparatus which eject a liquid from a liquid ejecting head is an ink-jet printer. The ink-jet printer performs printing by carrying paper while traveling a recording head as a liquid ejecting head mounted on a carriage and discharging ink droplets as a liquid from the recording head. A recording head has a nozzle group which formed on the bottom of the recording head. Ink droplets are discharged from the nozzle group. The ink-jet printer may suffer from ink thickening or clogging due to evaporation of ink solvent in a nozzle or nozzle blocking due to deposition of dust while printing is halted. Also, air bubbles may invade from the opening of a nozzle to invite improper printing such as dot dropouts. In order to prevent such nozzle blocking and dot dropouts, the inkjet printer performs cleaning to suck ink in the recording head when specified by the user. To perform the cleaning, the ink-jet printer is equipped with a capping unit for sealing a nozzle forming face of the recording head and a pump unit having a tube pump for applying a negative pressure on the capping unit.

The tube pump has a pump wheel rotating in the forward and backward directions and a roller. The pump wheel is connected to a drive motor. By applying a pressure onto and deforming the tube connected to the capping unit by way of the roller moving in accordance with the rotation of the pump wheel, a negative pressure is applied to the capping unit. A plurality of values are set as the rotation speed and the ink suction speed may be varied by varying the rotation speed of the tube pump. A cleaning has a regular suction where high speed rotation is performed to enhance the discharge performance of air bubbles and a micro-suction where low speed rotation is performed to suck bubbled ink (for example, refer to the JP-A-11-138859). In the regular suction, the ink suction speed must be high enough to obtain sufficient discharge performance of the air bubbles.

In case a tube pump is continuously rotated at a high speed in order to provide a sufficiently high ink suction speed during the regular suction, the consumption power could be increased. On the other hand, in case a tube pump is rotated at a low speed so as to gradually increase the suction speed of the ink or the rotation speed of the tube pump is gradually increased, the tube pump operating time is prolonged, which may increase the power consumption and ink consumption volume.

### SUMMARY OF THE INVENTION

It is therefore an object of the present invention to provide a liquid ejecting apparatus capable of suppressing the power consumption for cleaning and minimizing the degradation of a tube pump.

In order to achieve the above object, as set forth in the present invention, there is provided a liquid ejecting apparatus comprising:

a liquid ejecting head, having a nozzle from which a liquid is ejected;

a capping unit, sealing the liquid ejecting head;

a tube pump, applying a negative pressure to the capping unit by rotating operation to suck a fluid; and

a controller, varying a rotation speed of the tube pump,

wherein the controller rotates the tube pump at a first rotation speed for a first predetermined time; and

wherein the controller rotates the tube pump at a second rotation speed lower than the first rotation speed for a second predetermined time after rotating the tube pump at the first rotation speed for the first predetermined time.

In the configuration, the tube pump is rotated at the first rotation speed for the first predetermined time so that it is possible to increase the suction speed of the fluid from the capping unit in a relatively short time. It is thus possible to shorten the time required to increase the suction speed as well as suppress the liquid volume consumed until the suction speed is increased. It is possible, when the suction speed is increased, to drive the tube pump at the second speed as a relatively low rotation speed. It is thus possible to reduce the power required to drive the tube pump while maintaining the suction speed of a fluid from the capping unit to a high speed.

Preferably, the first predetermined time is a time from a start of the rotating operation of the tube pump to when a suction speed at which the tube pump sucks the fluid reaches a predetermined value.

In the configuration, it is possible to rotate a tube pump at a high speed until the suction speed at which the tube pump sucks a fluid reaches a predetermined value. Thus, it is possible to shorten the time required until the suction speed reaches a predetermined value.

Preferably, a plurality of rotation speeds of the tube pump capable of increasing a suction speed of the fluid to a predetermined value are set to the controller. The controller rotates the tube pump at one rotation speed of the set rotation speeds of the tube pump for a predetermined time. The controller rotates the tube pump at another rotation speed of the set rotation speeds of the tube pump lower than the one rotation speed for a predetermined time after rotating the tube pump at the one rotation speed.

In the configuration, it is possible to rotate the tube pump at a high speed until the suction speed at which the tube pump sucks a fluid reaches the predetermined value. Thus, it is possible to shorten the time required until the suction speed reaches the predetermined value as well as suppress the liquid volume consumed until the suction speed reaches the predetermined value. It is possible, when the suction speed is increased, to drive the tube pump at a relatively low rotation speed. It is thus possible to reduce the power required to drive the tube pump while maintaining the suction speed of a fluid from the capping unit to a high speed.

According to the present invention, there is also provided a method for controlling a liquid ejecting apparatus, comprising the steps of:

providing a liquid ejecting head which has a nozzle from which a liquid is ejected;

providing a capping unit which seals the liquid ejecting head;

providing a tube pump which applies a negative pressure to the capping unit by rotating operation to suck a fluid;

setting a plurality of rotation speeds of the tube pump capable of increasing a suction speed of a fluid to a predetermined value;

rotating the tube pump at one rotation speed of the rotation speeds of the tube pump for a predetermined time in a high speed rotation stage; and

rotating the tube pump at another rotation speed of the rotation speeds lower than the one rotation speed for a predetermined time in a low speed rotation stage after the step of rotating the tube pump in the high speed rotation stage.

In the method, it is possible, in the high speed rotation stage, to increase the suction speed of the fluid from the capping unit. Thus, it is possible to shorten the time required until the suction speed reaches a predetermined value as well as suppress the liquid volume consumed until the suction speed reaches the predetermined value. It is possible, when the suction speed is increased, to drive the tube pump at a speed lower than that in the high speed rotation stage. It is thus possible to reduce the power required to drive the tube pump while maintaining the suction speed of the fluid from the capping unit to a high speed.

Preferably, the rotating of the tube pump in the low speed rotation stage is performed when the suction speed of the fluid is reached the predetermined value in the high speed rotation stage.

In the method, in the high speed rotation stage, it is possible to drive the tube pump at a high speed until the suction speed of the fluid from the capping unit reaches the predetermined value. Thus, it is possible to shorten the time required until the suction speed reaches a predetermined value as well as suppress the liquid volume consumed until the suction speed reaches the predetermined value. It is possible, when the suction speed has reached the predetermined value, to drive the tube pump at a rotation speed lower than that in the high speed rotation stage. It is thus possible to reduce the power consumption while maintaining the suction speed of the fluid from the capping unit to a predetermined value.

Preferably, the rotating of the tube pump in the low speed rotation stage is performed when a time predicted that the suction speed of the fluid is reached the predetermined value is elapsed in the high speed rotation stage.

In the method, it is possible to drive the tube pump at a high speed until the time predicted that the suction speed of the fluid is reached the predetermined value. It is thus possible to shorten the time required to reach the predetermined value as well as suppress the liquid volume consumed until the predetermined value is reached. It is possible, when it is expected that the predetermined time is reached, drive the tube pump at a speed lower than that in the high speed rotation stage. It is thus possible to reduce the power consumption while maintaining the suction speed of the fluid from the capping unit to the predetermined value.

Preferably, the rotating of the tube pump in the high speed rotation stage and the rotating of the tube pump in the low speed rotation stage are successively performed.

In the method, in a shift from the high speed rotation stage to the low speed rotation stage, attenuation of the suction speed of the fluid which has reached the predetermined value is minimized. It is thus possible to maintain section of the fluid to the predetermined value.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view of the main section of an ink-jet printer main unit according to an embodiment of the present invention;

FIG. 2 is a conceptual drawing of capping unit and a tube pump according to the embodiment;

FIG. 3 is a block diagram of a control circuit according to the embodiment;

FIG. 4 is a graph illustrating the ink suction speed according to the embodiment; and

FIG. 5 is a graph illustrating the ink suction speed according to the embodiment.

### DETAILED DESCRIPTION OF THE PREFERRED EMBODIMENTS

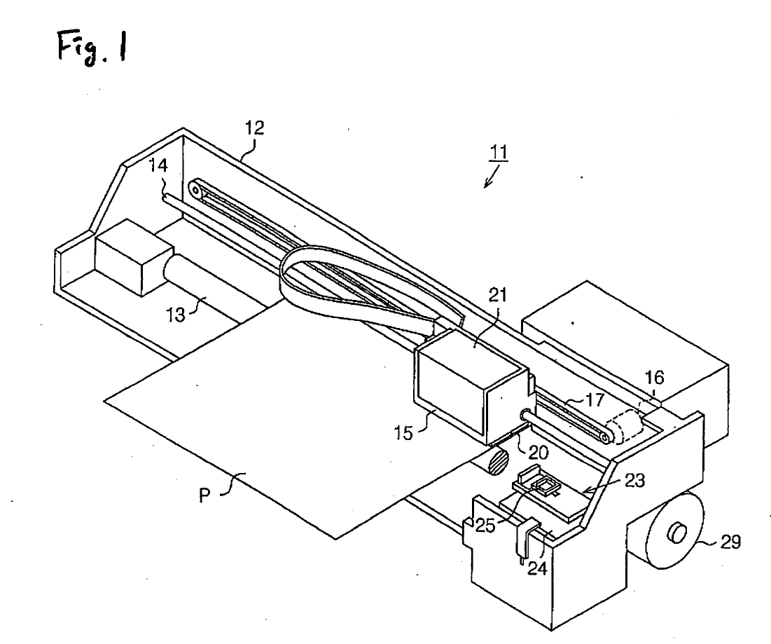

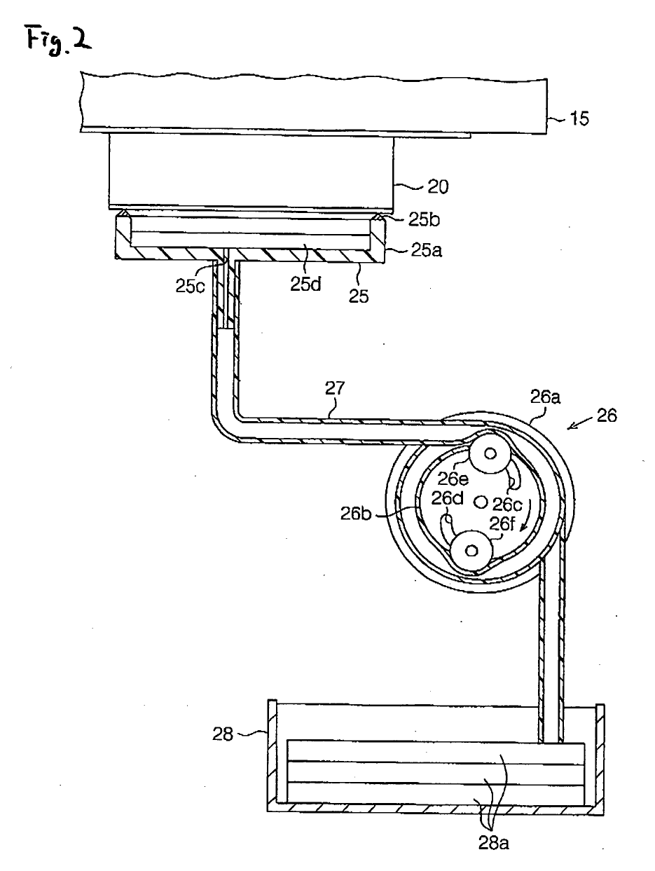

The embodiment of the invention will be described referring to FIGS. 1 through 5.

FIG. 1 is a perspective view of the main section of an ink-jet printer main unit (hereinafter referred to as a printer main unit) as a liquid ejecting apparatus. The printer main unit 11 has a frame 12 and a platen 13 inside the frame 12. A guide member 14 is arranged in parallel with the platen 13. A carriage 15 is slidably supported along the guide member 14. The carriage 15 is reciprocated in the main scan direction by a carriage motor 16 provided outside the frame 12 via a timing belt 17 looped in parallel with the guide member 14. On the carriage 15 is provided a recording head 20 having a nozzle group for discharging a black ink and various color inks as opposed to recording paper P. The nozzles of the recording head 20 is supplied ink from each ink cartridge 21 mounted on the carriage 15 and discharge the ink onto the recording paper P to print characters and images. The recording paper P is fed in the sub-scan direction by a paper feed mechanism (not shown) in accordance with the travel of the carriage 15.

In the non-print area to the right of the frame 12 are provided capping unit for sealing the opening portion of the nozzles of the recording head 20 and a pump unit 24 having a tube pump 26 (see FIG. 2). The capping unit 23 includes a cap 25 and an elevating unit (not shown) for traveling the cap 25 upward and downward. In the capping unit 23, when the carriage 15 travels to the non-print area, the elevating unit lifts the cap 25 to seal the recording head 20.

When cleaning is performed to suck the ink in the recording head 20, the nozzle forming face of the recording head 20 is sealed by the cap 25 and a negative pressure is applied in the cap 25 by the pump unit 24 connected to the cap 25 so that the ink in the recording head is sucked. The sucked ink is stored in a waste ink tank 28 (see FIG. 2).

FIG. 2 is a schematic view showing the tube pump 26 and the cap 25 which seals the recording head 20. For convenience, only the sectional view is provided only with regard to the main part. The cap 25 includes a cap holder 25a and a cap member 25b of a flexible material such as elastomer in the shape of a rectangle arranged at the upper end of the cap holder 25a. A bottom of the cap 25 has an outlet 15c to which one end of a tube 27 is connected. The other end of the tube 27 is connected to the waste ink tank 28. The tube pump 26 is arranged between the outlet 15c and the waste tank 28. A waste ink absorber 28a of a porous material which absorbs the recovered ink, is provided in the waste ink tank 28.

When the cap 25 is elevated by the elevating unit and the cap member 25b comes into contact with the recording head 20, the space enclosed by the nozzle forming face and the cap 25 is almost sealed. When the tube pump 26 is driven in this state, the air and ink as fluids in this space are sucked to generate a negative pressure which is applied to a nozzle. The ink in the nozzle is discharged from the outlet 25c formed on the bottom of the cap holder 25a.

A sheet-shaped ink absorber 25d is provided in the cap holder 25a. The ink absorber 25d receives ink discharged from a nozzle and temporarily stores the ink. When the nozzle forming face is sealed with the cap 25, the humidity in the cap 25 is maintained high so as to prevent drying of the ink in the nozzle.

The tube pump 26 provided at a midpoint of the tube 27 is fixed to a frame 12. The tube pump 26 includes a pump frame 26a, a pump wheel 26b and rollers 26c, 26d traveling along roller supporting grooves 26c, 26d formed on the pump wheel 26b. The pump frame 26a restricts the travel of the tube 27 in the outer direction in the shape of an arc. The tube 27 including an overlapping section (section the tube 27 is arranged over the pump frame 26a) is arranged between the pump frame 26a and the pump wheel 26b.

The pump wheel 26b rotates as driven by a paper feed motor 29 (see FIG. 1). When the pump wheel 26b is rotated in the forward direction (arrow direction in FIG. 2), the rollers 26e, 26f move out along the radius of the wheel in the roller supporting grooves 26c, 26d and rotates while sequentially crushing the tube 27. This reduces the pressure inside the tube 27 upstream of the tube pump 26. The air or ink inside the cap 25 sealing the nozzle forming face is gradually discharged in the direction of the waste ink tank 28 by way of the rotation of the pump wheel 26b, thus accumulating a negative pressure inside the cap 25.

When the pump wheel 26b is rotated in the backward direction (direction opposite to the arrow direction in FIG. 2), the rollers 26e, 26f move in along the radius of the wheel in the roller supporting grooves 26c, 26d. This brings the rollers 26e, 26f into the release state where they come in slight contact with the tube 27. As a result, the internal pressure of the tube pump 26 becomes uniform.

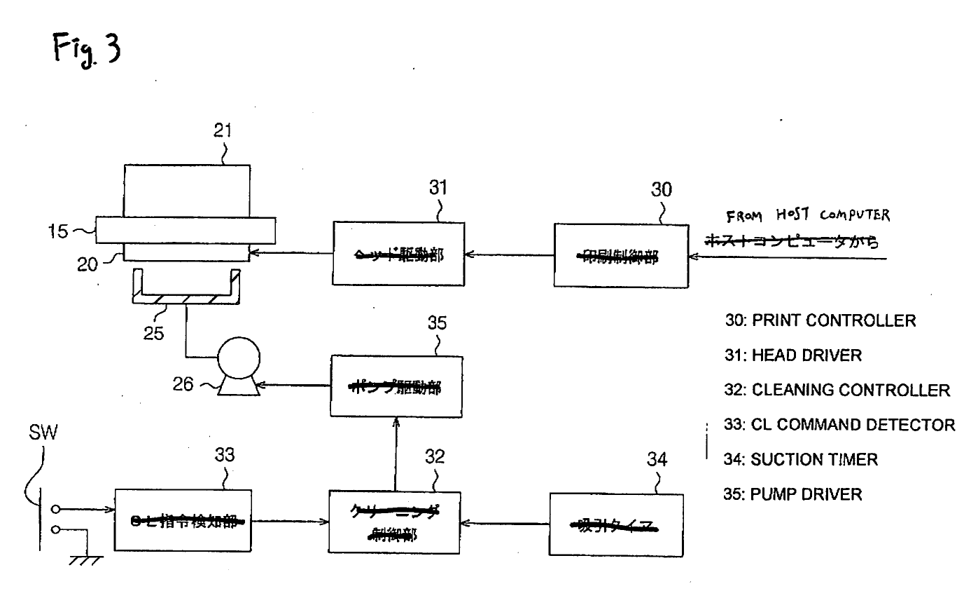

FIG. 3 is a block diagram showing the control circuit of a printer thus configured. A print controller 30 generates bitmap data as droplet injection data based on print data from the host computer of the printer. Based on the data, the print controller 30 instructs a head driver 31 to generate a drive signal to discharge ink from the recording head 20.

A cleaning controller 32 as a controller accesses data concerning the suction time and suction intensity stored in a storage (not shown) at power on or in response to a signal from a cleaning (CL) command detector 33 and a suction timer 34. The cleaning command detector 33 detects ON/OFF of the cleaning command switch SW provided on the printer case. The cleaning controller 32 controls the tube pump 26 via a pump driver 35. The pump driver 35 in this example is a paper feed motor 29 which rotates in steps of a predetermined angle. Thus the rotation speed of the tube pump 26 is variable in accordance with the frequency of the input pulse signal of the pump driver 35.

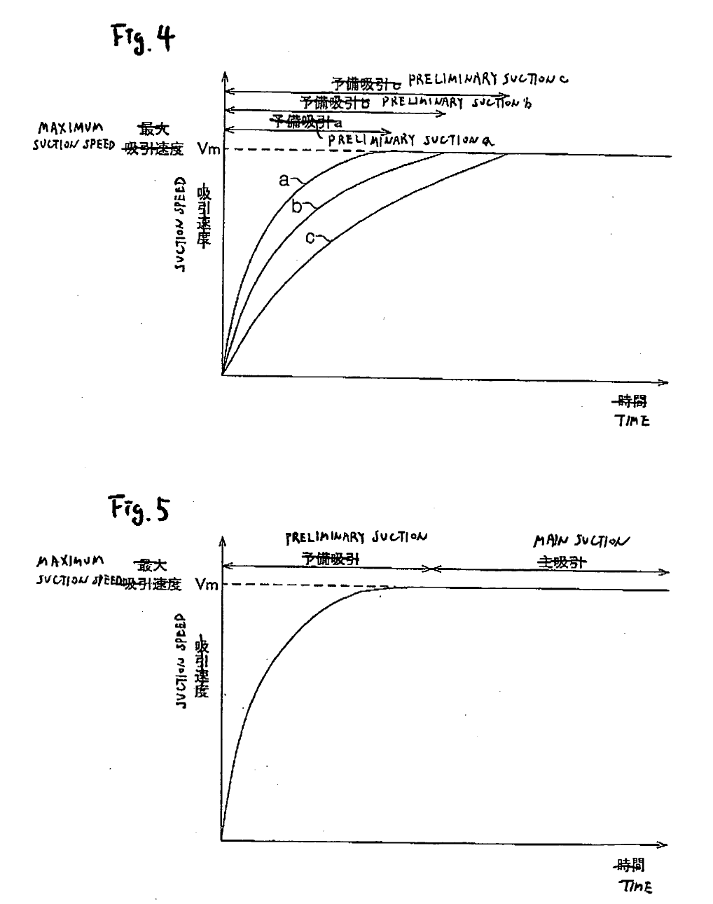

The data such as the suction time stored in the storage (not shown) is a fixed value, so that the frequency of a pulse signal supplied to the pump driver 35 is fixed to for example 4100 Hz, 3600 Hz, 2400 Hz, or 1200 Hz. FIG. 4 shows the suction speed of the tube pump 26 relative to the elapsed time assumed when these pulse signals are continuously supplied to the pump driver 35. The curves a through c represent the suction speed corresponding to the elapsed time obtained from the rotation speeds a through c of the tube pump 26. The rotation speed a is a rotation speed obtained when the frequency of the pulse signal supplied to the pump driver 35 is 4100 Hz. The rotation speed b is a rotation speed obtained when the frequency of the pulse signal supplied to the pump driver 35 is 3600 Hz. The rotation speed c is a rotation speed obtained when the frequency of the pulse signal supplied to the pump driver 35 is 2400 Hz.

When the tube pump is rotated at one of the rotation speeds a through c, the rotation speed finally reaches a predetermined suction speed. Thus, the curves a through c in FIG. 4 converge to the maximum suction speed Vm as a predetermined value such as 0.2 cc/sec as the time elapses. This is due to the fact that the nozzle diameter of the recording head 20 is small and the channel resistance is large, thus the speed of the ink discharged from the nozzle is limited even when a greater negative pressure is applied by the tube pump 26 and the suction speed of the tube pump 26 is limited.

In addition to these rotation speeds, a pulse signal having a relatively low frequency such as 1200 Hz may be supplied to the pump driver 35. The suction speed obtained by the rotation speed of the tube pump 26 assumed in case the pulse signal is supplied does not reach the maximum suction speed Vm. The pulse signal is used to drive the pump driver 35 in the bubbled ink in the cap 25 is to be sucked. The pulse signal is not transmitted in case air bubbles or thickened ink in a nozzle is to be sucked.

In order to discharge air bubbles or thickened ink in a nozzle of the recording head 20, a negative pressure applied to the air bubbles or thickened ink must be increased. It is thus desirable to increase the suction speed. Cleaning for discharging air bubbles is set to maintain for a predetermined time a state where the ink suction speed has reached the maximum suction speed Vm. To attain the maximum suction speed Vm, it is necessary to perform preliminary suction where the tube pump 26 is previously driven and the negative pressure in the tube 27 upstream of the tube pump 26 or in the cap 25 is gradually increased. The preliminary suction is a suction operation from when the tube pump 26 started rotation at one speed to when the suction speed has reached the maximum suction speed Vm. The time required for preliminary suction as a predetermined time depends on the rotation speed of the tube pump 26. The time required for the preliminary suction when the tube pump 26 is rotated at a highest rotation speed a is shorter than that required when the tube pump is rotated at a rotation speed b, c. Thus, in case the tube pump is rotated at the rotation speed a, the time required for preliminary suction is shortened and the ink volume consumed by preliminary suction can be suppressed.

When the tube pump 26 is constantly rotated at the rotation speed a during cleaning, the power consumption is increased. Once the suction speed has reached the maximum suction speed Vm and is kept constant, the maximum suction speed Vm is maintained due to the negative pressure accumulated in the cap 25 and the inertial force of ink, irrespective of which speed of the rotation speeds a through c is used to rotate the tube pump 26. Note that rotation speeds where the maximum suction speed Vm can be maintained do not include a relatively small rotation speed which will not allow the suction speed to reach the maximum suction speed Vm.

Next, the rotation speed of the tube pump 26 assumed when cleaning is performed to discharge air bubbles or thickened ink is described below referring to FIG. 5. FIG. 5 is a graph showing the ink suction speed relative to the elapsed time during a cleaning process. When the cleaning controller 32 receives a cleaning execution command from the cleaning command detector 33, the cleaning controller 32 drives the tube pump 26 at the rotation speed a for preliminary suction as a high speed rotation stage via the pump driver 35. A negative pressure is applied in the tube 27 upstream of the tube pump 26 and in the cap 25 to gradually increase the ink suction speed. The tube pump 26 is rotated at the rotation speed a, so that the maximum suction speed Vm is attained in the shortest time among the set rotation speeds.

When the tube pump 26 is rotated at the rotation speed a and the time set for preliminary suction at the rotation speed a as predetermined time has elapsed, the tube pump 26 is rotated at the rotation speed c to perform main suction as a low speed rotation stage. The ink suction speed is maintained to the maximum suction speed Vm even when the tube pump 26 is rotated at the rotation speed c since the ink suction speed has reached the maximum suction speed Vm after the preliminary suction is performed. The main suction is a suction operation to apply a negative pressure to air bubbles and thickened ink in a nozzle to discharge the air bubbles and thickened ink. When the time set for the main suction as a predetermined time has elapsed from the main suction started, the main suction is complete. Thus the main suction can suppress power consumption when compared with the case where the tube pump 26 is driven at the rotation speed a.

The above-mentioned embodiment provides the following advantages:

(1) In this embodiment, the cleaning controller 32 supplies pulse signals having different frequencies. A plurality of frequencies which allow the ink suction speed to reach the maximum suction speed Vm can be set as these frequencies. One of the pulse signals is supplied to the pump driver 35 so that the pump driver 35 rotates the tube pump 26 in accordance with the frequency of the input pulse signal. During cleaning to suck air bubbles and thickened ink, preliminary suction is performed at the rotation speed a as the maximum speed and main suction is performed at the rotation speed c which is lower than the rotation speed a.

Thus, in the preliminary suction, the time required to attain the maximum suction speed Vm is shortened and the ink consumption volume in the preliminary suction is suppressed. Once the maximum suction speed Vm is attained, the tube pump 26 is driven at a rotation speed lower than the rotation speed a. This makes it possible to reduce power consumption while maintaining the ink suction speed to the maximum suction speed Vm to assure discharge performance of air bubbles. Reduction of power consumption reduces the heating volume of a motor for driving the pump, thereby suppressing noise. Reduced time for the preliminary suction and lower rotation speed in the main suction minimize degradation of the tube pump such as wear of the tube 27.

(2) In this embodiment, the preliminary suction where the tube pump 26 is rotated at a relatively high speed and the main suction where the tube pump 26 is rotated at a relatively low speed are performed in succession. Thus, the attenuation of the ink suction speed after reaching the maximum suction speed Vm is minimized in the switchover from the preliminary suction to the main suction. It is thus possible to efficiently maintain the ink suction speed to the maximum suction speed Vm.

The above embodiment may be modified as follows:

While cleaning is executed when the user has pressed the cleaning command switch SW in the embodiment, cleaning may be executed after a long-hour printing pause or every predetermined period.

Cleaning to such air bubbles and thickened ink includes a stage where the tube pump 26 is rotated at a rotation speed a and a stage where the tube pump 26 is rotated at a rotation speed c in the embodiment. In the stage where the tube pump 26 is rotated at a rotation speed c, the tube pump 26 may be rotated at a rotation speed b or another speed which is lower than the rotation speed a. Note that the rotation speeds are those which maintain the maximum suction speed Vm and do not include a rotation speed which will not allow the suction speed to reach the maximum suction speed Vm after a predetermined time.

While the tube pump 26 includes two rollers 26e, 26f in the embodiment, the tube pump 26 may be otherwise configured. For example, the tube pump 26 may include a single roller alone or include a tube so as not to form an overlapping section.

While the liquid ejecting apparatus is an ink-jet printer in the embodiment, the invention may be applied to a liquid ejecting apparatus which ejects a liquid other than ink. Such a liquid ejecting apparatus may be a liquid ejecting apparatus which ejects a liquid such as an electrode material or color material used for fabrication of a liquid crystal display, EL display or FED (field emission display), a liquid ejecting apparatus which ejects a biological organic substance used for bio-chip fabrication, or a sample ejecting apparatus as a micro-pipet.

What is claimed is:

1. A liquid ejecting apparatus comprising:
a liquid ejecting head, having a nozzle from which a liquid is ejected;
a capping unit, sealing the liquid ejecting head;
a tube pump, applying a negative pressure to the capping unit by rotating operation to suck a fluid; and
a controller, varying a rotation speed of the tube pump,
wherein the controller rotates the tube pump at a first rotation speed for a first predetermined time; and
wherein the controller rotates the tube pump at a second rotation speed lower than the first rotation speed for a second predetermined time after rotating the tube pump at the first rotation speed for the first predetermined time.

2. The liquid ejecting apparatus as set forth in claim 1, wherein the first predetermined time is a time from a start of the rotating operation of the tube pump to when a suction speed at which the tube pump sucks the fluid reaches a predetermined value.

3. The liquid ejecting apparatus as set forth in claim 1, wherein a plurality of rotation speeds of the tube pump capable of increasing a suction speed of the fluid to a predetermined value are set to the controller;
wherein the controller rotates the tube pump at one rotation speed of the set rotation speeds of the tube pump for a predetermined time; and
wherein the controller rotates the tube pump at another rotation speed of the set rotation speeds of the tube pump lower than the one rotation speed for a predetermined time after rotating the tube pump at the one rotation speed.

4. A method for controlling a liquid ejecting apparatus, comprising the steps of:
providing a liquid ejecting head which has a nozzle from which a liquid is ejected;
providing a capping unit which seals the liquid ejecting head;
providing a tube pump which applies a negative pressure to the capping unit by rotating operation to suck a fluid;
setting a plurality of rotation speeds of the tube pump capable of increasing a suction speed of a fluid to a predetermined value;
rotating the tube pump at one rotation speed of the rotation speeds of the tube pump for a predetermined time in a high speed rotation stage; and
rotating the tube pump at another rotation speed of the rotation speeds lower than the one rotation speed for a predetermined time in a low speed rotation stage after the step of rotating the tube pump in the high speed rotation stage.

5. The method as set forth in claim 4, wherein the rotating of the tube pump in the low speed rotation stage is performed when the suction speed of the fluid is reached the predetermined value in the high speed rotation stage.

6. The method as set forth in claim 4, wherein the rotating of the tube pump in the low speed rotation stage is performed when a time predicted that the suction speed of the fluid is reached the predetermined value is elapsed in the high speed rotation stage.

7. The method as set forth in claim 4, wherein the rotating of the tube pump in the high speed rotation stage and the rotating of the tube pump in the low speed rotation stage are successively performed.
